(19) United States
(12) Patent Application Publication
(10) Pub. No.: US 2026/0003645 A1
(43) Pub. Date: Jan. 1, 2026

(54) MACHINE-LEARNED ARCHITECTURE FOR STRUCTURED SYNTHETIC DATA GENERATION

(71) Applicant: Salesforce, Inc., San Francisco, CA (US)

(72) Inventors: Aditi Shreya, Parikhara (IN); Manan Dey, Guwahati (IN); Dharani Gopal Akkiraju, Medchal (IN); Joao Tiago Azevedo Belo, High Wycombe (GB); Hariharan Mani, Chennai (IN)

(21) Appl. No.: 19/074,314

(22) Filed: Mar. 7, 2025

(30) Foreign Application Priority Data
Jun. 27, 2024 (IN) 202411049238

(51) Int. Cl. G06F 9/448; G06F 9/445; G06N 3/045

(52) U.S. Cl. CPC G06F 9/4488; G06F 9/44505; G06N 3/045

(57) ABSTRACT

Techniques may generate realistic synthetic data by programmatically generating a configuration file object type and relationship data. This configuration file may be used to retrieve source data matching the object type(s) and/or specific records indicated by the configuration file. The techniques may detect and anonymize private/proprietary information and may determine statistical characteristic(s) of the source data. A batch of prompt(s) may be generated using the source data, the statistical characteristic(s), and the configuration file and may be transmitted to one or more instances of a transformer-based machine-learned model. Sets of synthetic data received from the model instance(s) may be de-duplicated, checked for similarity to the source data (e.g., via embedding the synthetic data and the source data), and may be used to generate synthetic object(s) using the relationship(s) and/or other data indicated by the configuration file. These synthetic object(s) may then be deployed in a software environment.

### CROSS-REFERENCE TO RELATED APPLICATION(S)

This application claims the benefit of Indian Provisional Application No. 202411049238, filed on Jun. 27, 2024 and titled “MACHINE-LEARNED ARCHITECTURE FOR STRUCTURED SYNTHETIC DATA GENERATION,” which is incorporated by reference herein in its entirety.

### TECHNICAL FIELD

One or more example implementations relate to the field of synthetic data generation by a machine-learned model pipeline that obfuscates personal and confidential information and creates structured synthetic data that preserves characteristics of an original set of data.

### BACKGROUND

Generative machine-learned models create new data from data a user supplies. However, at scale, such models may generate repetitive or unrealistic data, which may be unsuitable for testing a development environment. Generative machine-learned models are also generally trained to a checkpoint using general data that is broadly available in broad data sets and fine-tuning such a model may not yield results that are specific to a particular software environment. In other words, data generated by such a machine-learned model may not replicate realistic production data in a software environment. Using realistic data as input in an attempt to achieve more realistic test data may violate privacy or cybersecurity best practices. Moreover, a software environment may change with development and/or data structures related the software environment may change as users modify use of the underlying data structures. Accordingly, users may need to manually define data structures, schemas, and rules to tailor test data. Even then, such tailored test data may be prone to errors when attempting to use such data to test a software environment.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical components or features. The figures are not drawn to scale.

FIG. 1 illustrates an example system for performing techniques described herein.

FIGS. 2A-2E illustrate a pictorial flow diagram of an example process for generating realistic synthetic objects that are natively configured for a software production environment and that obfuscate personal information and preserve original characteristics of source data.

### DETAILED DESCRIPTION

As discussed above, testing a software production environment with realistic test software objects presents a number of problems, including restrictions on using real software objects. For example, these restrictions could include an entity creating a software production environment without access to any software objects to start with or having access to software objects that include proprietary or private information. Moreover, even with the advent of large language models, such models may not be all that helpful for generating realistic test software objects since such data may not have realistic characteristics in comparison to existing software objects and/or the data generated by such models can't natively be deployed as a software object. For example, a large language model may produce a table or list of text, but such a table or list in such a form cannot be uploaded to a software production environment without a user formatting such text using a data structure for a particular software object. Also, automated methods for formatting text into a software object may still cause errors due to the text being incorrectly parsed or by including incorrect data in a software object data structure. Moreover, a human may need to set up custom rules for such an automated method for each set of data produced by a large language model and further custom rules depending on variations between and future changes to a production environment, software object data structure, and/or the like.

The techniques discussed herein may include software, hardware, and/or machine-learned models that generate synthetic software object(s) that may be deployed in a software environment, such as to test the software environment. In some examples, the techniques may comprise receiving a user indication of a type of object to generate and/or an indication of existing software object(s) to use as a basis for generating the synthetic object(s). The techniques may query a host computing service that maintains metadata identifying a data structure of such object(s) and/or relationship(s) between an object type and other object type(s) for the software environment. In some examples, relations between objects may be indicated in a relational database or other similar sort of database. For example, the relational database may indicate that an opportunity object type is related to an account object type and a contact object type, but that the contact object type is only related to the contact object type, and that the account object type has no relations, thereby indicating an implied directionality of the relations. Additionally or alternatively, the relationship may indicate that the opportunity and account object types are related and a directionality of the relationship (e.g., opportunity to account).

Regardless, the techniques may comprise using a response to the query to generate a configuration file that specifies the object type(s), their relationship(s) (if any), and default parameters, such as field(s) associated with an object type, fields to check for duplication after generation of synthetic data, and/or the like. In some examples, the default parameters may be altered by a user, such as by reducing the field(s) to generate in association with an object type, modifying the fields to check for duplication and de-duplicate, and/or adding specific object(s) to use are part of the generation operations discussed herein.

In some examples, a user may specify a number of synthetic objects to generate or, if this number is absent, the techniques may generate a default number of synthetic objects, such as a number of synthetic objects equal to the source objects retrieved as discussed below, a multiple of this number, or a pre-set number. Regardless, the number provided by the user or the default number may be included in the configuration file or stored and provided as part of the prompt generation process discussed below.

Based at least in part on receiving an indication from the user, such as activation of a user interface element to initiate the generation and/or indicating finalization of any selections made by the user that are used to generate the configuration file, the techniques may comprise querying a database hosted by the host computing service that stores existing software objects. In some examples, this database may be inaccessible to a current user that is generating the synthetic objects, or the user may have access to the database (in which case the user is permitted to select software objects to add to the configuration file as a basis for the synthetic data generation).

In response to the query, the host computing service may retrieve and temporarily store or identify object(s) in the database that satisfy criteria specified by the configuration file. For example, these may be software object(s) of the object type(s) specified in the configuration file and/or software object(s) having object identifiers indicated in the configuration file as being associated with specific object(s) selected by the user.

This set of objects may comprise at least a first set of objects having a first object type and a second set of objects having a second object type in an example where the configuration file specifies at least two types of objects. The data contained by the first set of objects and the second set of objects is referred to herein as source data. For example, an object may comprise a set of data indicated in different fields or other portions of the object, where that set of data is a subset of the source data.

The techniques may comprise using a machine-learned model and/or regular expression(s) to detect any private information contained in the source data and using another machine-learned model to generate synthetic data to replace that data. In some examples, the techniques may additionally or alternatively comprise determining statistical characteristic(s) of the source data. For example, determining the statistical characteristic(s) may comprise determining a frequency, rate, ratio, and/or distribution of occurrences in the source data, such as naming conventions, data formatting, or the like associated with a field or set of fields indicated by object(s) of a same type, and/or whether a relationship indicated as existing by the configuration file between two types of objects is empty or exists between a first object and a second object of the two. For example, this could include a ratio of dates indicated in MMDDYYY format to dates indicated in MM-DD-YY format, etc.; numbers indicated in (###) ###-#### format to numbers indicated in #(###) ###-####, ###-###-####, and ## formats; a percentage of objects of a first object type indicated by the configuration file as being related to a second object type including a link or other relationship to object(s) of the second object type; and/or the like. In some examples, a statistical characteristic may be stored in association with a particular field of an object, a combination of fields, relationships between two sets of objects of different object types, and/or the like for which the statistical characteristic was determined.

In some examples, the statistical characteristic may additionally or alternatively indicate a set or range of entries associated with a field or group of fields. For example, some objects have portions (e.g., fields) thereof that may be populated by user selection of one or more options from a list or numeric value(s) determined by a machine or supplied by a user. The statistical characteristic may indicate a subset of the entries from the list that are indicated in the source data, a ratio or percentage at which each entry appears, or the like; and/or a range of numeric value(s) and/or a probability distribution determined based at least in part on a range of numeric value(s) in the source data.

The techniques may additionally or alternatively comprise determining a number of prompts to generate a sufficient number of synthetic data sets to create the synthetic objects requested by the user or specified by the default number discussed above. In some examples, the number of synthetic data sets requested to be generated by a machine-learned model may be multiplied by a multiplicand, such as 1.1, 1.5, 2, or any other positive integer equal to or greater than one. For example, the number of synthetic data sets to be generated may exceed the number requested by the user to account for synthetic data that may be deleted during post-processing to remove duplicates. Regardless, determining the number of prompts to generate a sufficient number of synthetic data sets may be based at least in part on determining the number of tokens the machine-learned model can receive as input and can output, and estimating the number of tokens associated with the source data and/or a number of tokens associated with the synthetic data to be generated by the model based at least in part on the source data and the statistical characteristics.

Once a number of prompts have been determined, the techniques may comprise populating each prompt with different portions of the source data. A prompt may comprise a portion of the source data, a base prompt (e.g., a large language model prompt template), statistical characteristic(s) of the source data, a number of synthetic data sets for the large language model to generate based on the prompt (e.g., the number of synthetic data sets to be generated divided by the number of prompts), a seed value, and/or the like. In some examples, the techniques may comprise asynchronously transmitting these prompts, once complete, to different instances of a transformer-based machine-learned model, which may reduce the total time to generate the synthetic data sets by generating the synthetic data sets in parallel.

In examples where multiple prompts are generated, an instance of the transformer-based machine-learned model may use a prompt generated as described herein to generate a subset of synthetic data. Collectively, multiple instances of the transformer-based machine-learned model (or different transformer-based machine-learned models) may generate a set of synthetic data, which may be received by the host computing service and processed to generate synthetic objects. In some examples, the base prompt may instruct the transformer-based machine-learned model instance(s) to generate the synthetic data as a JSON list or other format where different sets of synthetic data may be delineated by a demarcation between different sets of synthetic data. For example, the demarcation may be a specific series of symbols that may be detected by a regular expression. In individual set of synthetic data may be used to generate a single synthetic object, or, in examples where a duplicate is detected in post-processing, a corresponding portion of a different set of (extra) synthetic data may be used to replace a portion of the duplicate portion of synthetic data.

In some examples, the techniques may comprise detecting any duplicates across the synthetic data sets for those fields indicated in the configuration file for de-duplication. Any detected duplicates may be replaced with data from an extra synthetic data set in examples where extra synthetic data is generated, i.e., where the number of synthetic data requested to be generated exceeds the number requested by the user. If no extra synthetic data sets remain, the techniques may comprise transmitting a new prompt to the transformer-based machine-learned model with a different seed value than any of the seed values used in the prompts supplied to the transformer-based machine-learned model so far.

The techniques may additionally or alternatively comprise determining embeddings for the source data and the synthetic data and determining a similarity metric (e.g., a cosine similarity, whether a synthetic data embedding lies within a threshold distance of a cluster centroid of a cluster determined based at least in part on source data embeddings) between the two sets of embeddings. If the similarity metric for equal to or more than a threshold percentage (e.g., 75%, 80%, any other majority percentage) of the synthetic data does not meet a threshold similarity metric, the synthetic data may be used to generate synthetic objects. Otherwise, at least part of the synthetic data for which a similarity metric does not meet the threshold similarity metric may be replaced with extra synthetic data sets (or portions thereof) or, if no enough extra synthetic data sets remain, a new prompt may be transmitted to the transformer-based machine-learned model to generate new set(s) of synthetic data. In some examples, the synthetic data may be reviewed, via regular expressions and/or a machine-learned model, for any synthetic data that doesn't conform to a data structure specified by the configuration file. In some examples, any data that doesn't conform to the data structure may be modified by a machine-learned model to conform to the data structure.

Once a sufficient percentage of synthetic data meets or exceeds the threshold similarity metric, the synthetic data may be used to generate synthetic objects. This may comprise filling a field of a synthetic object with a portion of a synthetic data set that corresponds with that field. Additionally or alternatively, this may comprise filling a field of a synthetic object with a portion of a synthetic data set that refers or links to a portion synthetic data in a different synthetic object, which may comprise portions or fields of such a synthetic object that is filled with synthetic data from a different set of synthetic data. This linking may establish relationships between two types of synthetic objects via a hyperlink, synthetic data that matches a type and is indicated as being related via the configuration file, or the like.

After links/relationships have been created between synthetic objects according to the statistical characteristics of relationships in the original source data, the synthetic objects may be deployed to the software environment, such via uploading the synthetic objects to a database, software production environment, or the like.

The techniques discussed herein may produce realistic synthetic data that may increase the effectiveness of testing a software production environment, such as software-as-a-service hosted by a the host computing service, a distributed storage and/or data transmission system, and/or the like. Without this more realistic synthetic data, edge cases that may cause errors may not be detected before the software production environment is in production (i.e., goes live for access to a broader number of users beyond administration and/or development user(s). The techniques may reduce errors in the software components' operations and/or in uploading synthetic data to one or more software components. Additionally, the programmatically-generated configuration file may reduce or remove the need for custom rule sets or manual user editing or definitions of data structure(s) and/or schema(s) to generate realistic synthetic data, as the configuration file may dynamically change as changes are made to data structure(s) and/or relationships therebetween used by the software production environment. This may reduce the maintenance overhead for the software production and/development environment and a number of errors that may result from uploading the synthetic objects to the host computing service. Furthermore, the techniques described herein may ensure that the synthetic objects generated by the system discussed herein mask private and/or proprietary data, improving the system's privacy and cybersecurity posture.

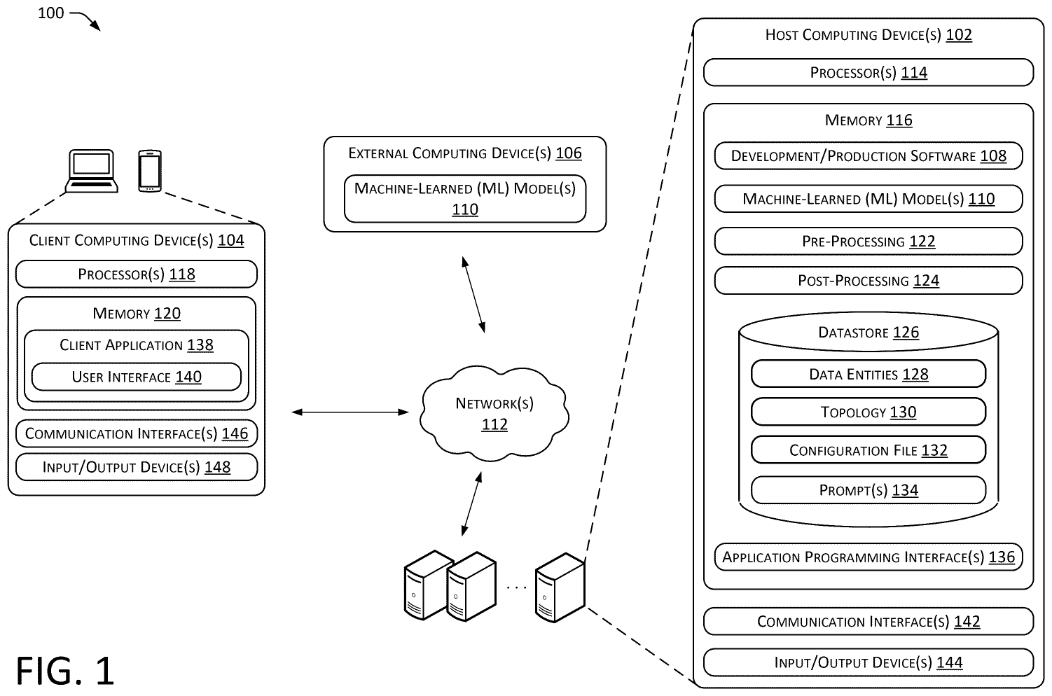

FIG. 1 illustrates an example environment 100 for performing the techniques described herein. The techniques discussed herein may be used in a variety of environments and for a variety of uses, although the examples given herein discuss a customer service environment as one of these use cases since it's a use case familiar to many. In additional or alternate examples, the computing environment may comprise computing devices used for cybersecurity, search engines, multi-agent/agentic machine-learned model pipeline(s) and/or cluster(s), machine-learned model training, cloud/distributed computing or massive computing efficient data storage and/or retrieval, and/or the like.

In at least one example, the example environment 100 can include one or more computing devices, such as host computing device(s) 102, client computing device(s) 104, and/or external computing device(s) 106. By way of example and not limitation, the host computing device(s) 102 may be representative of servers for hosting the software, hardware, containers, and/or the like to implement at least part of the techniques discussed herein. For example, the host computing device(s) 102 may host (e.g., store and/or execute) development and/or production software 108. The computing device(s) 104 may be representative of user computing device(s) associated with a first user (i.e., a first “client device”).

The host computing device(s) 102 may comprise one or more individual servers or other computing devices that may be physically located in a single central location or may be distributed at multiple different locations. The host computing device(s) 102 communication may be hosted privately by an entity administering all or part of the environment 100 (e.g., a utility company, a governmental body, distributor, a retailer, manufacturer, etc.), or may be hosted in a cloud environment, or a combination of privately hosted and cloud hosted services. In some examples, the functional components and/or data discussed herein can be implemented on a single server, a cluster of servers, a server farm or data center, a cloud-hosted computing service, a cloud-hosted storage service, and so forth, although other computer architectures can additionally or alternatively be used. Moreover, the host computing device(s) 102 may comprise hardware and/or software containers accessible to different tenants with access to the host computing device(s) 102.

The computing device(s) 104 and/or 106 may be any suitable type of computing device, e.g., portable, semi-portable, semi-stationary, or stationary. In some examples, external computing device(s) 106 may comprise one or more individual servers or other computing devices that may host at least some of the machine-learned model(s) 110 in an example where all the machine-learned model(s) 110 are not hosted by the host computing device(s) 102, although, in some examples, the machine-learned model(s) 110 may be entirely hosted by the host computing device(s) 102 or the external computing device(s) 106. Some examples of computing device(s) 104 can include a tablet computing device, a smart phone, a mobile communication device, a laptop, a netbook, a desktop computing device, a terminal computing device, a wearable computing device, an augmented reality device, an Internet of Things (IoT) device, or any other computing device capable of sending communications and performing the functions according to the techniques described herein. In some examples, the client computing device(s) 104 may comprise distributed computing devices, server(s), etc.

In some examples, the host computing device(s) 102, client computing device(s) 104, and/or external computing device(s) 106 may be configured to transmit network packages therebetween via network(s) 112. The network(s) 112 can include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, cellular network, or any other such network, or any combination thereof. The network(s) 112 may comprise a single network or collection of networks, such as the Internet, a corporate intranet, a virtual private network (VPN), a local area network (LAN), personal area network (PAN), metropolitan area network (MAN), a wireless local area network (WLAN), a cellular network, a wide area network (WAN), a metropolitan area network (MAN), or a combination of two or more such networks, over which the client computing device(s) 104 and/or external computing device(s) 106 may transmit a query to and/receive an output from the machine-learned model(s) 110 or communicate with other user computing device(s) via the communication platform. Components used for such communications can depend at least in part upon the type of network, the environment selected, or both. Further, the network(s) 112 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the group-based communication system. In some embodiments, the protocol is a custom protocol of JSON objects sent via a Websocket channel. In some embodiments, the protocol is JSON over RPC, JSON over REST/HTTP, and the like.

Each of the computing devices described herein may include one or more processors and/or memory. Specifically, in the illustrated example, host computing device(s) 102 include processor(s) 114 and memory 116 and client computing device(s) 104 include processor(s) 118 and memory 120.

By way of example and not limitation, the processor(s) 114 and/or 118 may comprise one or more central processing units (CPUs), graphics processing units (GPUs), tensor processing units (TPUs), field-programmable gate arrays (FPGAs), and/or process-acceleration devices such as application-specific integrated circuits (ASICs) or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions.

The memory 116 and/or 120 may comprise one or more non-transitory computer-readable media and may store software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/flash-type memory, RAM, ROM, EEPROM, flash memory, optical storage, solid state storage, magnetic tape, magnetic disk storage, RAID storage systems, storage arrays, network attached storage, storage area networks, cloud storage, or any other medium for storing information. The architectures, systems, and individual elements described herein may include many other logical, programmatic, and physical components, of which those shown in the accompanying figures are merely examples that are related to the discussion herein. The memory 116 and/or 120 can be used to store any number of software/functional components that are executable by the processor(s) 114 and/or 118, respectively. In many implementations, these functional components comprise instructions or programs that are executable by the processor(s) 114 and/or 118 and that, when executed, specifically configure the processor(s) 114 and/or 118 to perform the actions attributed to the machine-learned model(s) 110, host computing device(s) 102, and/or client computing device(s) 104, according to the discussion herein.

For example, host computing device(s) 102 may comprise a memory 116 storing the development and/or production software 108, which may comprise any software component(s) that are to be tested with the synthetic data objects generated according to the techniques discussed herein. For example, in a cybersecurity development and production environment, the software component(s) may comprise a security information and event management (SIEM) component, a configuration and asset information management component, an endpoint detection and response (EDR) component, an intrusion detection system (IDS), an intrusion prevention system (IPS), a data loss prevention (DLP) component, an identity and access management (IAM) component, a network security monitoring (NSM) component, a threat intelligence platform (TIP), and/or the like. In a customer service or sales environment, the software component(s) being developed and/or tested may comprise sales automation, lead management, sales forecasting, customer service case management, customer self-service, marketing automation and/or customer engagement, e-commerce tool, business intelligence and/or analytics, application development tool, and/or machine-learned model component(s).

In some examples, the host computing device(s) 102 may comprise a memory 116 storing the machine-learned model(s) 110 discussed herein. In some examples, the machine-learned model(s) 110 may be stored and executed at the hot computing device(s) 102 and/or external computing device(s) 106. In some examples, the machine-learned model(s) 110 may comprise a machine-learned model for determining statistical characteristic(s) associated with source data. Such a machine-learned model may comprise a principal component analysis (PCA), an autoencoder, exploratory data analysis component, neural network that models data distributions, a regression model, or the like. Depending on the type of statistical characteristic(s) determine, the statistical characteristic component may additionally or alternatively determine frequency, ratio, percentage, and/or other calculations.

In some examples, the machine-learned model(s) 110 may additionally or alternatively comprise a machine-learned model, such as a neural network or transformer-based machine-learned model, such as a large-language model (LLM), that detects and/or masks private and/or proprietary information. For example, private data may include phone numbers, names, personal address(es), social security numbers, or the like. Proprietary information may comprise information like financial data, trade secrets, potential sales, and even the name of a company in some contexts. The machine-learned model may detect that such data exists and may generate data of a similar type to replace the private or proprietary information. For example, if a name is detected, such data may be replaced with a name that preserves a same formatting as the original name (e.g., where the original name is “R. Wagner,” the machine-learned model may generate a name that is a letter followed by a last name, like “J Smith”). Similarly, if a phone number is detected, the machine-learned model may generate a new number in the same format or may scramble the original phone number, preserving the format of the original data. Such as machine-learned model may comprise a transformer-based machine-learned model, such as an LLM like a generative pre-trained transformer (GPT) 3.5, bidirectional encoder representations from transformers (BERT), Fairseq, XLNet, T5, or the like; and/or a neural network, such as a long short-term memory (LSTM) memory, convolutional neural network, gated recurrent units (GRUs), sequence-to-sequence (Seq2Seq) models, capsule network(s), and/or the like.

In some examples, the machine-learned model(s) 110 may additionally or alternatively comprise a machine-learned model that tokenizes data, i.e., breaks up input data into smaller parts, and encodes these tokens as embeddings. For example, such a machine-learned model may comprise an encoder portion of a transformer-based machine-learned model (e.g., a component that uses layer(s) of self- and/or cross-attention) to determine the embedding. one or more encoders that have the same or different architectures and that at least have different parameters as determined according to the training process. Additionally or alternatively, an encoder may comprise the encoder portion of a BERT model, the encoder portion of a GPT 3.5 model, Ada2, singular value decomposition (SVD), a VGG network, global vectors for word representation (GloVe), Word2Vec, t-distributed stochastic neighbor embedding (t-SNE), or the like. An embedding may comprise a vector or tensor representation of the input data in a high-dimensional space, where distance in the embedding space represents differentiation in characteristics between data sets projected into the embedding space. However, the dimensionality of an embedding may still be lower than a dimensionality of the original data used to generate an embedding. Such an embedding may be determined as an intermediate part of generating the synthetic data discussed herein and/or may be used to determine a similarity between source data and synthetic data, as discussed further herein.

In an example where the embeddings are used as an intermediate part of generating synthetic data, the embedding(s) generated for input data, such as one of the prompts discussed herein, may be provided as input to a decoder of a transformer-based machine-learned model, such as the decoder portion of a GPT 3.5 model, the decoder portion of a BERT model, and/or the like. Note that the transformer-based machine-learned model could be any other LLM trained on a large data set and/or fine-tuned on production data of the software environment discussed herein.

In an example where the embeddings are used to determine a similarity between source data and synthetic data, the encoder may use the source data to determine a first set of embeddings and may use the synthetic data to determine a second set of embeddings. The techniques discussed herein may comprise determining a similarity metric based at least in part on the first set of embeddings and the second set of embeddings. For example, the techniques may comprise determining, as the similarity metric, a cosine similarity or distance between an embedding of the first set of embeddings and an embedding of the second set of embeddings. The techniques may comprise determining a percentage of the second set of embeddings that have a similarity metric that meets or exceeds a threshold similarity metric and determine whether the percentage mects or exceeds a threshold percentage to determine whether the synthetic data is sufficiently similar to the source data, thereby further ensuring the realism of the synthetic data. Additionally or alternatively, an additional machine-learned model (i.e., a clustering model), such as k-means, hierarchical, density-based spatial clustering of applications with noise (DBSCAN), or other clustering method may determine a set of clusters based at least in part on the first set of embeddings and the techniques may comprise determining a percentage of the second embeddings that fall within a cluster, are within a threshold distance of a centroid or medoid of a nearest cluster, or the like and determining whether this percentage meets or exceeds a threshold percentage.

In some examples, the machine-learned model(s) 110 may additionally or alternatively comprise a transformer-based machine-learned model, such as an LLM and/or neural network(s), that determines the synthetic data based at least in part on the prompt(s) discussed herein. In some examples, multiple instances of this transformer-based machine-learned model may be instantiated in order to asynchronously generate subsets of the synthetic data in parallel. Instantiating an instance of the transformer-based machine-learned model may comprise transmitting a call to a hypervisor, a container orchestration system (e.g., Kubernetes®, Docker Swarm®, Elastic Container Service®) or the like with a prompt generated as discussed herein and containing a request to instantiate a new instance of the transformer-based machine-learned model, either in a new container, pod, or the like or in a container, pod, or the like that already runs another instance of the transformer-based machine-learned model.

In some examples, the machine-learned model(s) 110 may additionally or alternatively comprise a neural network, such as a convolutional neural network, graph neural network (GNN), multi-layer perceptron(s) (MLP(s)), Kolmogorov-Arnold network(s) (KAN(s)), and/or the like; or a transformer-based machine-learned model that populates a field of a data structure with synthetic data to create a software object of a first object type. Additionally or alternatively, such a neural network and/or transformer-based machine-learned model may create a relationship between two object types by populating a field of a first software object's data structure with data indicated in a field of a different software object. Such a neural network and/or transformer-based machine-learned model may conduct this populating based at least in part on a first set of synthetic data associated with a first software object type and/or statistical characteristics indicated as being associated with that first software object type to create software objects of the first object type; and/or may use a first set of synthetic data associated with a first software object type, a second set of synthetic data associated with a first software object type, and/or statistical characteristics associated with a relationship between the first and second software object types. Additionally or alternatively, software object(s) and/or relationships therebetween may be generated programmatically by a deterministic software component.

In some examples, any of the machine-learned model(s) 110 discussed herein may be pre-trained using general language data and/or may be trained on a training dataset from production data using supervised, semi-supervised, or unsupervised learning. In at least one example, the training dataset used herein may comprise semi-supervised or supervised labels of a field being associated with an event or not (e.g., field contains proprietary information, field contains private information, field data is to be formatted according to a first format). The ML model may be run with the training dataset and produces a result, which is then compared with a target, for each input vector in the training dataset. Based on the result of the comparison and the specific learning algorithm being used, the parameters of the model may be adjusted according to gradient descent to reduce a loss determined based at least in part on the comparison. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's parameters (e.g., weights, biases, B-spline parameters and/or weights). In some examples, the host computing device(s) 102 may train the machine-learned model(s) 110.

In some examples, one or more of the machine-learned model(s) 110 may be part of the pre-processing component(s) 122 and/or post-processing component 124 discussed herein. For example, the pre-processing component(s) 122 may comprise software, hardware, and/or machine-learned model(s) for programmatically generating the configuration file, masking private and/or proprietary information, determining statistical characteristic(s) of source data, tokenizing the source data, generating and/or transmitting the prompt(s), and/or the like. The post-processing component 124 may comprise software, hardware, and/or machine-learned model(s) for de-duplicating the synthetic data, validating the synthetic data conforms to a data type and/or data structure, determining a similarity metric between the synthetic data and the source data, creating the synthetic objects and relationships therebetween, and/or deploying the synthetic objects.

The memory 116 may additionally or alternatively comprise a portion of memory 116 (e.g., one or more memories or a portion of a single memory) that collectively forms a datastore 126 (e.g., a database) that stores data entities 128, a topology 130 generated from configuration file 132, the configuration file 132, and/or prompt(s) 134 (e.g., both the base prompt(s) for different object types and/or temporary storage of prompt(s) for generating synthetic data). A data entity may comprise content and a data type that identifies a file format, data structure format, or a portion of a file or data structure (e.g., a field) of the particular data entity. For example, a data entity may comprise a software object. The content may comprise any type of data, such as text, audio, an image, a document file, a data structure, a database, and/or the like. The data entities 128 may differ depending on the environment 100 in which the techniques discussed herein are deployed. In a customer relationship management example, the data entities 128 may comprise things like case(s) (e.g., data structures indicating various data recording interactions with a customer such as messages sent between external computing device(s) 106 and the client computing device(s) 104 and/or host computing device(s) 102, digital interactions of the external computing device(s) 106 with a website hosted by the host computing device(s) 102), a case comment (e.g., a status of a case, data/content added to a case data structure), a message (e.g., chat transcript, email), document(s) (e.g., a knowledge article in the form of a webpage or a document file, a product document, a purchase order, an invoice), and/or other file(s), such as image(s), audio, and/or the like.

In some examples, the topology 130 may comprise a graph that may be generated from a relational database and/or based at least in part on the configuration file 132 according to the discussion herein. In some examples, the relational database may be part of the datastore 126 and may be generated and maintained as part of the saving functions in the portion of memory attributable to the datastore 126. Additionally or alternatively, the datastore 126 may comprise a metadata file that indicates relationship(s) and/or data structure(s) of any of the data entities 128, which may be used to create the configuration file 132 and/or the topology 130. In some examples, the data entities 128 may comprise a subset of the data entities 128 that is used as source data to generate synthetic data. The synthetic data may be temporarily stored in the datastore 126 and may be used to generate the synthetic objects, which may be stored in the datastore 126 and indicated, by a metadata file, as being accessible to a set of users upon deployment of the synthetic objects.

Additionally or alternatively, the datastore 126 may store the base prompt(s) and may temporarily store the prompt(s) generated according to the discussion here. A prompt may comprise a base prompt (e.g., a pre-configured prompt template associated with the object type(s) for which the synthetic data is to be generated), statistical characteristic(s), a subset of the source data, a seed value, information from the configuration file characterizing the subset and/or the synthetic data to be generated, and/or a number of synthetic data sets requested to be generated.

It will be appreciated that the terms “datastore,” “database,” “repository,” and “network database” may be used interchangeably in areas of the present disclosure. As used herein, the terms “data,” “content,” “digital content,” “digital content object,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like. Moreover, data may be transmitted, received, or otherwise exchanged as individual “data objects” comprising interrelated data. Data objects may constitute single bits of data or large quantities of interrelated data, such as substantive data (e.g., the underlying content to be conveyed through a communication) and associated metadata (e.g., data not otherwise considered to be substantive data, encompassing characteristics of the substantive data and/or the relevant exchange (e.g., the identity of the user sending the data, the identity of the user receiving the data, the time/date when the data was sent, formatting to be associated with the exchanged substantive data, the file type of the data object, and/or the like).

The memory 116 may additionally or alternatively store application programming interface(s) (API(s) 136), hypervisor(s), container orchestration system(s), an operating system, and/or container (unillustrated). The API(s)) 136 may expose back-end functions and/or services hosted by the host computing device(s) 102 to the client computing device(s) 104, external computing device(s) 106, and/or different component(s) hosted by the host computing device(s) 102 without transferring the functions/services/software to those computing device(s) and/or by accomplishing the functions and/or services at the host computing device(s) 102. As relates to the instant discussion, this may comprise API(s) for receiving indications from a user (e.g., as part of an API call) and/or the external computing device(s) 106, or from different ones of the components.

In some examples, software executed at the client computing device(s) 104, such as a client application 138, may generate API call(s) to the API(s) 136 and/or any of the component(s) discussed herein may transmit call(s) to the API(s) 136 and/or receive responses from the API(s) 136. For example, a user interface 140 executed by a client application 138 may display actuatable/selectable options to indicate object type(s) for which to generate synthetic objects, specific existing object(s) to use as part of the source data for generating the synthetic objects, a number of synthetic object(s) to create, particular field(s) of an object type to generate synthetic data for, and/or the like. In some examples, the client application 138 may interface with the API(s) 136 to authenticate a user and grant or deny the user access to a portion of the datastore 126 and/or development and/or production software 108.

The memory 116 may additionally or alternatively an operating system and/or container. In some examples, one or more containers may be instantiated by a cloud orchestrator and may run the operating system and may execute one or more instances of the API(s) 136, machine-learned model(s) 110, pre-processing component(s) 122, post-processing component(s) 124, and/or development/production software 108 and may permit access to a portion of the datastore 126 according to permissions associated with a user and an organization associated with the container. In some examples, deploying the synthetic object(s) discussed herein may comprise granting access to a portion of the datastore 126 containing the synthetic objects to a container running development and/or production software 108. In an additional or alternate example, the API(s) 136, machine-learned model(s) 110, pre-processing component(s) 122, post-processing component(s) 124, and/or development/production software 108 may run in one or more virtual machines or natively on the host computing device(s) 102. In at least one example, the operating system can manage the processor(s), memory, hardware, software, etc. of the host computing device(s) 102.

In some examples, the host computing device(s) 102 may further comprise communication interface(s) 142, which can include one or more interfaces and hardware components for enabling communication with various other devices (e.g., the user computing device 104), such as over the network(s) 112 or directly. In some examples, the communication interface(s) 142 can facilitate communication via WebSockets, APIs (e.g., using API calls), Hypertext Transfer Protocols (HTTPs), etc. The host computing device(s) 102 can further be equipped with various input/output devices 144 (e.g., I/O devices). Such I/O devices 144 can include a display, various user interface controls (e.g., buttons, joystick, keyboard, mouse, touch screen, etc.), audio speakers, connection ports, and so forth.

In at least one example, the client computing device(s) 104 can include processor(s) 118, memory 120, communication interface(s) 146, and/or input/output device(s) 148. The memory 116 may store and execute a client application 138. In some examples, the client application 138 may be configured to authenticate a user to access data and/or services hosted by the host computing device(s) 102. The API(s) 136 may filter the data entities 128 accessible depending on permissions granted to a type of user profile and/or an organization associated with the user. In at least one example, a user profile to which a user authenticates can include permission data associated with permissions of individual users of the platform. In some examples, permissions can be set automatically or by an administrator of the platform, an employer, enterprise, organization, or other entity that utilizes the platform, a team leader, a group leader, or other entity that utilizes the platform for communicating with team members, group members, or the like, an individual user, or the like. Permissions associated with an individual user can be mapped to, or otherwise associated with, an account or profile. In some examples, permissions can indicate which users can communicate directly with other users, which channels a user is permitted to access, restrictions on individual channels, which workspaces the user is permitted to access, restrictions on individual workspaces, and the like. In at least one example, the permissions can support the platform by maintaining security for limiting access to a defined group of users. In some examples, such users can be defined by common access credentials, group identifiers, or the like, as described above.

In some examples, the client application 138 may additionally or alternatively comprise instructions executable by one or more processors to provide a user interface 140. For example, the user interface 140 may comprise a graphical user interface (GUI), that the instructions may cause to be displayed via at least one of the input/output device(s) 148. In at least one example, the client application 138 can be a mobile application, a web application, a database interface (e.g., such as an application that presents a SQL or other database interface), or a desktop application. For example, a computing device of the one or more computing device(s) 104 and/or external computing device(s) 106 may access the API(s) 136 via a web browser or stand-alone application (either of which may be part of or host the client application 138) that communicates via network(s) 112 with API(s) 136.

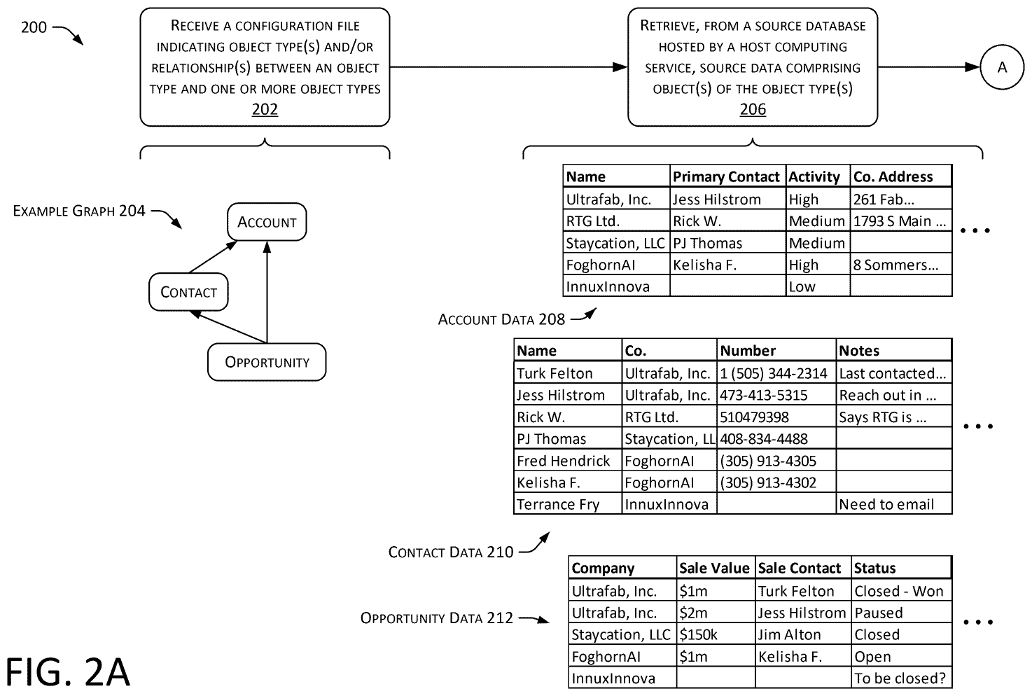

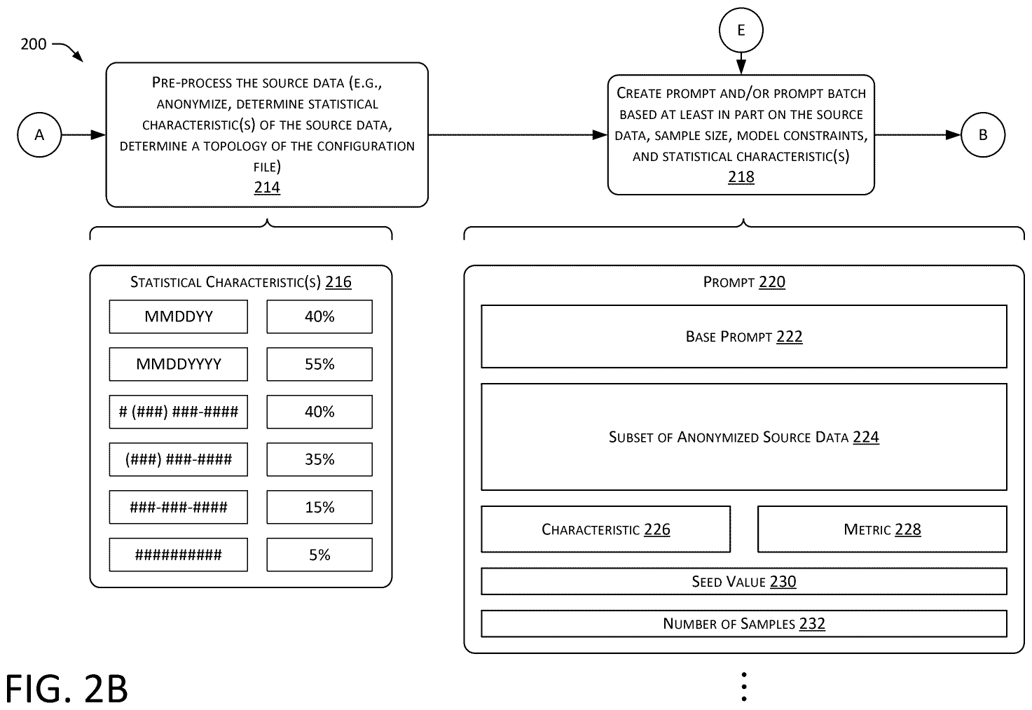

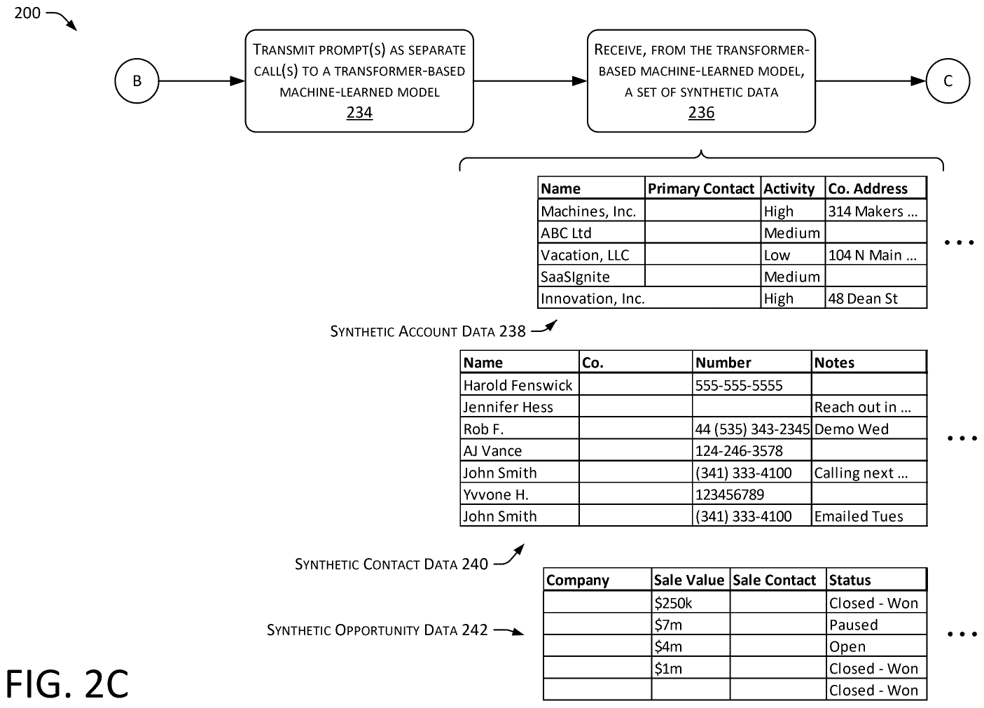

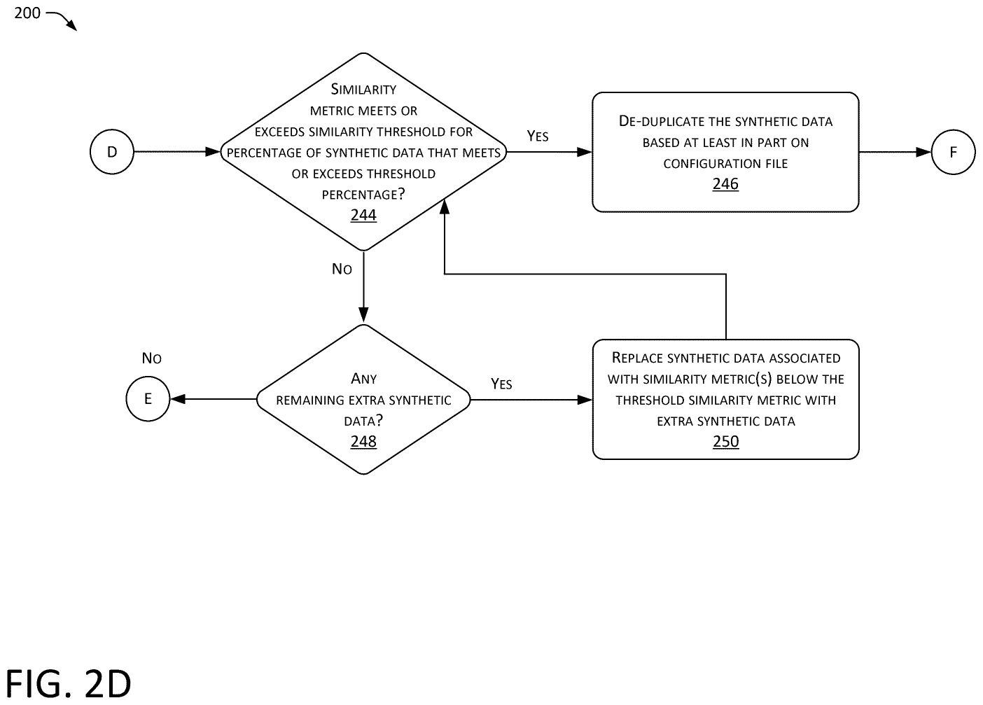

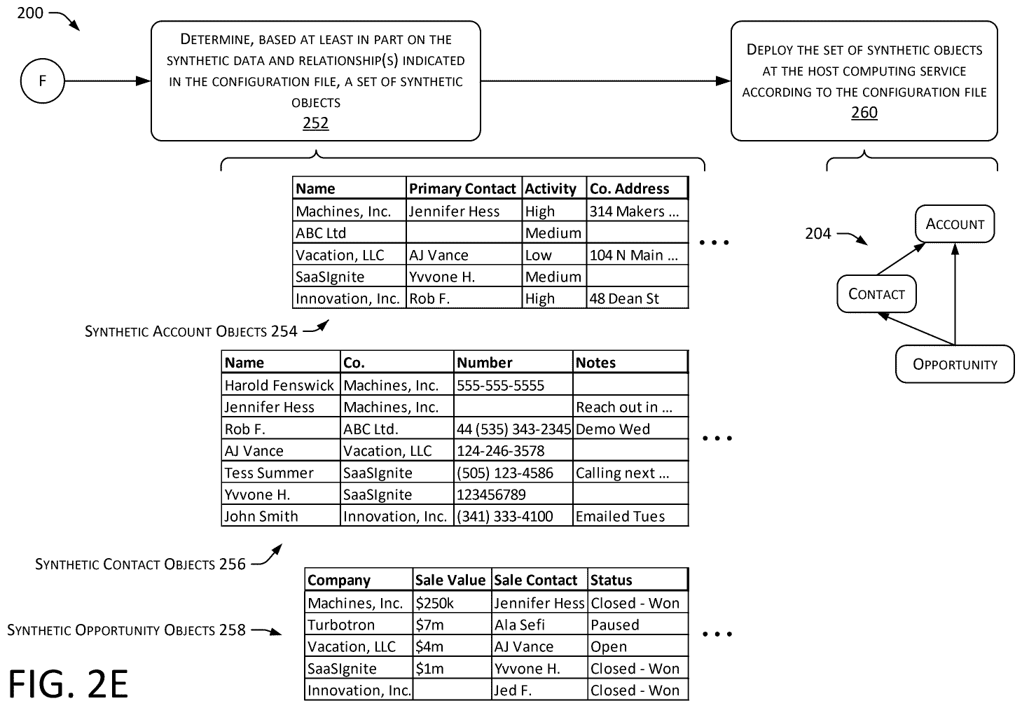

FIGS. 2A-2E illustrate a pictorial flow diagram of an example process 200 for generating realistic synthetic objects that are natively configured to be deployed to a software development or production environment and that obfuscate personal information and preserve original characteristics of the source data used to generate the synthetic object(s). In some examples, example process 200 may be executed by a host computing service, such as host computing device(s) 102. In some examples, example process 200 may additionally or alternatively comprise execution by the host computing device(s) 102 in coordination and/or interfacing with a client device, such as client computing device(s) 104 and/or external computing device(s) 106.

Turning to FIG. 2A, at operation 202, example process 200 can include receiving a configuration file indicating object type(s) and/or relationship(s) between an object type and one or more object types. In some examples, operation 202 may result from a user authenticating into a tenant system hosted by the host computing device(s) 102 and indicating object type(s) and a number of synthetic objects to generate. In some examples, the user may additionally or alternatively indicate a set of existing object(s) to use as part of the source data for generating the synthetic objects. Operation 202 may additionally or alternatively comprise transmitting an API query (e.g., REST, SOAP, metadata API) for the object type(s) to determine a field(s) and/or attribute(s) associated with each object type. For example, the field(s) and/or attribute(s) may comprise a datatype/data structure, default values, length, byte-length, a set of drop-down list entries, descriptor(s), and/or the like associated with an object type. In some examples, the user may select a subset of the fields to be populated with synthetic data. For example, if the fields associated with a first object type are indicated by the API response as being labeled “Name,” “Salutation,” and “Phone Number,” the user may indicate, via a user interface and in the configuration file, that synthetic data is to be generated for all or less than all of these fields for synthetic objects of this type. Additionally or alternatively, an API response may return object type(s) related to a particular object type. This data may be indicated as a label and/or API name of the relationship field for a particular object type. Additionally or alternatively, the API response and/or the user may specify a set of fields to check for duplicates and de-duplicates during post-processing of the synthetic data. The API calls, in this portion, may be transmitted to a metadata component of the datastore that indicates a current state of the production and/or development software environment that is automatically modified responsive to any changes in object relationship(s) and/or data structures used in the production and/or development software environment.

In the illustrated example, the configuration file may be generated based at least in part on the user instructing the system to generate “Account,” “Contact,” and “Opportunity” object types, e.g., by selecting those object type(s) generally and/or by selecting specific object(s) from the datastore that are indicated as being those object type(s). The system may programmatically generate the configuration file to specify field(s), related object(s), field(s) to de-duplicate, and/or the like for the synthetic object generation. FIG. 2A also illustrates an example graph 204 that may be generated based at least in part on the object type(s) indicated in the configuration file as being related to a specific object type. For example, the “Account” object type may not indicate any other objects as being related to “Account” objects, whereas the “Contact” object type is indicated by the configuration file as being related to “Account” objects and the “Opportunity” object type is indicated as being related to both “Contact” and “Account” objects. As subsequently noted, a graph, such as example graph 204 may be used to determine an order in which to create synthetic object(s) and/or relationship(s) between object(s) and/or to deploy synthetic object(s).

At operation 206, example process 200 may comprise retrieving, from a database hosted by a host computing service, source data comprising object(s) of the object type(s) indicated in the configuration file, and, if the user specified specific objects to include, additionally or only those objects. For example, operation 206 may comprise retrieving all, n, and/or the specific object(s), where n is a positive integer randomly sampled from the database accessible to the user or organization. In an example where the organization is permitted access to the objects, but the user isn't authorized to access the object(s) or some of the object(s), operation 206 may be conducted on the back-end without exposing to or giving the user access to the source data. In some examples, operation 206 may comprise stripping data from the software objects returned. For example, instead of returning an entire software object, which may comprise both a data structure and data indicated in different fields of the software object, operation 206 may determine a set of the source data based at least in part on determining the data indicated by the field(s) of an object that match the field(s) for that object type indicated by the configuration file. In some examples, this source data may be comprise a comma-separated values (CSV) file or another type of raw data file for each object type indicated in the configuration file.

In the illustrated example, operation 206 may result in retrieving source data comprising account data 208, contact data 210, and opportunity data 212 (at least a portion of which is depicted in the tables illustrated in FIG. 2A). Notably, each of these tables of data correspond to different object types, i.e., account object(s), contact object(s), and opportunity object(s), but may, in some examples, no longer comprise the data structure containing such data. Stripping data from such an object may comprise parsing an object according to the data structure and populating a CSV file or other raw data file format with the parsed data. Moreover, the source data may comprise data from any object(s) explicitly indicated by the user in the configuration file. The “Account” data 208 illustrated in FIG. 2A includes portions (fields) labeled “Name,” “Primary Contact,” “Activity,” and “Co. Address” and data for each of these fields that has been parsed from the original objects and added to the “Account” source data. The “Contact” data 208 includes fields labeled “Name,” “Co.,” “Number,” and “Notes” and corresponding source data; and the “Opportunity” data 212 includes fields labeled “Company,” “Sale Value,” “Sale Contact,” and “Status” and corresponding source data. As noted above, the source data in any of these sets of data may comprise n sets of data sampled from object(s) in the datastore having an object type that matches the object type requested and may additionally or alternatively include data from any objects explicitly referenced by the user in the configuration file.

Turning to FIG. 2B, at operation 214, example process 200 can include pre-processing the source data. In some examples, operation 214 may comprise parsing the data using label(s) and/or a known data structure associated with the source data. Additionally or alternatively, operation 214 may comprise detecting and/or masking any private and/or proprietary information. For example, detecting the private and/or proprietary information may be accomplished be determining data that returns a match to one or more regular expressions or for which a probability determined by a machine-learned model trained to detect private and/or proprietary information meets or exceeds a threshold likelihood. Such a machine-learned model may comprise a neural network or transformer-based machine-learned model and such a model may additionally or alternatively classify the type of data. Once private and/or proprietary information has been detected, the classification determined by the first machine-learned model, a classification associated with a regular expression that determined data that matches the regular expression, and/or the private and/or proprietary information itself may be used as input to another machine-learned model, such as a neural network or transformer-based machine-learned model that may generate masking data of the same type as the private and/or proprietary information. For example, where the private and/or proprietary information was a name, the second machine-learned model may generate a different name, or where the private and/or proprietary information was a phone number or social security number, the second machine-learned model may generate a number having the same format as the input number or as specified by the input to the second machine-learned model.

Operation 214 may additionally or alternatively determine one or more statistical characteristics associated with the source data. For example, operation 214 may comprise determining a statistical characteristic associated with data indicated in a particular field of the source data, a statistical characteristic associated with multiple fields of the source data, and/or a statistical characteristic associated with relationships between two object types. Operation 214 may comprise determining a rate, ratio, percentage, and/or probability distribution of occurrences in the source data, such as naming conventions, data formatting, or the like associated with a field or set of fields indicated by object(s) of a same type, and/or whether a relationship indicated as existing by the configuration file between two types of objects is empty or exists between a first object and a second object of the two. For example, this could include a ratio of dates indicated in MMDDYYY format to dates indicated in MM-DD-YY format, etc.; numbers indicated in (###) ###-#### format to numbers indicated in #(###) ###-####, ###-###-####, and ##formats; a percentage of objects of a first object type indicated by the configuration file as being related to a second object type including a link or other relationship to object(s) of the second object type; and/or the like. In some examples, a statistical characteristic may be stored in association with a particular field of an object, a combination of fields, relationships between two sets of objects of different object types, and/or the like for which the statistical characteristic was determined.

In some examples, the statistical characteristic may additionally or alternatively indicate a set or range of entries associated with a field or group of fields. For example, some objects have portions (e.g., fields) thereof that may be populated by user selection of one or more options from a list or numeric value(s) determined by a machine or supplied by a user. The statistical characteristic may indicate a subset of the entries from the list that are indicated in the source data, a ratio or percentage at which each entry appears, or the like; and/or a range of numeric value(s) and/or a probability distribution determined based at least in part on a range of numeric value(s) in the source data.

Some example statistical characteristic(s) 216 are depicted in FIG. 2B as percentages associated with different formats of dates (i.e., MMDDYY and MMDDYYY) and different formats of phone numbers (i.e., #(###) ###-####, (###) ###-####, ###-###-####, ##########), although other statistical characteristics are contemplated. In some examples, the statistical characteristic(s) 216 may additionally or alternatively indicate when a field or relationship is empty. Other examples of formats and/or data for which statistical characteristic(s) may be determined may include, for example, geolocation, checkbox state, date, email, a number, percent, time, and/or the like.

At operation 218, example process 200 may comprise creating a prompt and/or prompt batch comprising multiple prompts based at least in part on the source data, sample size requested by the user (i.e., number of synthetic objects to generate), model constraints of the model that will generate the synthetic data, and/or the statistical characteristic(s). In some examples, operation 218 may comprise determining a number of sets of synthetic data for the model to generate, which may be a number greater than the number requested by the user. For example, the number of sets requested for the model to generate may be a multiple of the number requested by the user, such as 1.1, 1.2, 1.5, or 2 times as many sets of synthetic data to account for post-processing operations that may discard some of the sets of synthetic data. Regardless, operation 218 may comprise determining a number of prompts to generate based on an estimated number of tokens that will result from tokenizing the source data and the other data that will be included in the prompt with the source data, such as the base prompt, statistical characteristic(s), seed value, and/or number of sampled to generate. The number of prompts to generate may then be determined based at least in part on a maximum number of tokens the model may receive as input and a maximum number of tokens the model may output. For example, this number may be determined based at least in part on determining the estimated number of token for a sample (subset) of the source data and determining an average token count per sample and dividing the estimated total token count by the maximum input and/or output tokens of the model. Using multiple prompts may allow multiple prompts to be sent to different instances of a same or different model, allowing for parallel synthetic data generation and accordingly shorter synthetic data latency.

In some examples, generating a prompt may comprise, such as the example prompt 220 depicted in FIG. 2B, may comprise including, in the prompt, a base prompt 222, a subset of anonymized source data 224, a characteristic 226 and its corresponding metric 228, a seed value 230, and a number of samples 232 requested (which may be incorporated into a portion of the base prompt). In some examples, the prompt may additionally or alternatively include parameter(s) and/or instructions to increase the diversity in the synthetic data generated, such as a temperature value. In some examples, the number of prompts to be generated may additionally or alternatively be based on the number of object types for which synthetic objects are to be generated.

The base prompt 222 may comprise pre-determined text that, in some examples, may be associated with a particular object type. In some examples, the base prompt may comprise text, an image, audio, and/or the like, depending on the particular object type. For example, the base prompt may specify a label for which to generate data (e.g., “generate company names, addresses, and phone numbers and ensure that none of the company names, addresses, and phone numbers match each other”) and a delineator to use between distinct sets of synthetic (e.g., a pattern of symbols that are uncommon that a regular expression could be used to detect, such as “$$$”, “∥∥”, “@@@@”, or the like). In some examples, the base prompt that the synthetic data is to be generated according to a particular data structure, such as YAML, JSON, HTML, or the like. The subset of anonymized source data 224 may comprise a subset of source data anonymized in examples where at least some private and/or proprietary data was masked at operation 214. In some examples, the subset may be chosen randomly and/or may be a next group of the source data that hasn't been included in a prompt yet.

The characteristic 226 may identify a field, set of fields, or relationship and the metric 228 may indicate a statistical quantifier for the characteristic 226. Collectively, the characteristic 226 and the metric 228 may compose a statistical characteristic that may be incorporated in the prompt as a requested feature of the synthetic data to be generated based on the prompt. For example, the characteristic 226 and metric 228 may be incorporated in the prompt as a statement, such as “generate a set of company names, addresses, and phone numbers, where 50% of the phone numbers are formatted as + #(###) #######, 40% of the phone numbers are formatted as ###-###-###, and 10% of the phone numbers are empty”). The prompt 220 may additionally or alternatively comprise a seed value that may be a randomly-generated number or other sequence of symbols that is different from seed value(s) indicated in any of the other prompt(s) being generated. Finally, the prompt 220 may indicate how many sets of synthetic data to generate. In some examples, a machine-learned model may generate the prompt 220 or the prompt may be created by populating fields of the prompt with the attendant data described above.

Turning to FIG. 2C, at operation 234, example process 200 may comprise transmitting the prompt(s) as separate calls(s) to a transformer-based machine-learned model. In an example where multiple prompts were generated, operation 234 may comprise transmitting the prompts to different instances of a same transformer-based machine-learned model and/or multiple instances of different types of transformer-based machine-learned models (in which case the base prompt may vary in some examples).

At operation 236, example process 200 may comprise receiving, from the transformer-based machine-learned model, a set of synthetic data. In examples where multiple prompts were transmitted, operation 236 may comprise receiving multiple subsets of synthetic data that, together, form the set of synthetic data. FIG. 2C illustrates example synthetic account data 238, synthetic contact data 240, and synthetic opportunity data 242. Note that fields that would indicate a relationship to another object type are empty. For example, synthetic opportunity data 242 does not comprise data in the “Company” field, which would identify and/or link to a set of “Account” data and the “Sale Contact” field of synthetic opportunity data 242 is similarly empty since it would identify a set of “Contact” data. Moreover, the synthetic contact data 240 does not data in the “Co.” field as this may be populated by and/or link to a portion of a set the “Account” data. Note that this may be accomplished in a variety of ways. For example, such fields may be populated and replaced with link(s) to and/or data from other sets of synthetic data.

Turning to FIG. 2D, at operation 244, example process 200 may comprise determining a similarity metric between the synthetic data and the source data. For example, operation 244 may comprise determining, by an encoder machine-learned model, a first set of embeddings for the source data and a second set of embeddings for the synthetic data and determining a similarity metric between the two sets of embeddings. For example, determining the similarity metric may comprise determining a cosine distance between an embedding of the first set of embeddings and an embedding of the second set of embeddings. Additionally or alternatively, determining the similarity metric may comprise determining a set of clusters based at least in part on the first set of embeddings and determining whether an embedding the second embeddings falls within a cluster, within a threshold distance of a centroid or medoid of a nearest cluster, or the like.

Operation 244 may additionally or alternatively comprise determining whether a threshold percentage of the embeddings of the second set of embeddings have similarity metrics determined therefor that meet or exceed a threshold similarity metric for equal to or more than a threshold percentage (e.g., 75%, 80%, any other majority percentage) of the embeddings of the second set of embeddings. If the percentage of the second set of embeddings meets or exceeds a threshold percentage a threshold similarity metric, the synthetic data may be used to generate synthetic objects/example process 200 may continue to operation 246. Otherwise, if the percentage is less than the threshold percentage, example process 200 may continue to operation 248.

At operation 248, example process 200 may determine if any extra synthetic data remains/is unused from the extra synthetic data sets that were generated in an example where extra synthetic data sets were requested as part of the prompt(s) generated at operation 218. If no extra data synthetic data sets remain, example process 200 may return to operation 218 to generate a new prompt and, subsequently, new synthetic data to replace a subset of the synthetic data for which a similarity metric was determined at operation 244 that does not meet or exceed the similarity metric threshold. For as many extra synthetic data sets that remain, example process 200 may continue to operation 250.

At operation 250, example process 200 may comprise replacing a set of synthetic data for which a similarity metric was determined that is below the threshold similarity metric with a set of extra synthetic data and returning to operation 244.

At operation 246, example process 200 may comprise de-duplicating the synthetic data based at least in part on a configuration. In some examples, operation 246 may use a regular expression, a Munkres match scoring function, or the like to determine that two sets of synthetic data comprise matching data for fields indicating in the configuration file for de-duplicating. For example, if the configuration file indicates that a “Name” field of “Account” data is to be de-duplicated, any matching data indicated in the “Name” field of the “Account” synthetic data may be replaced with data from a “Name” field of an extra synthetic data set or, if no such extra synthetic data remains, a new prompt to generate such data may be provided to the transformer-based machine-learned model for a “Name” that does not include any of the names in the “Account” synthetic data “Name” field data so far. In fields for which de-duplication is not requested, operation 246 may be skipped.

In some examples, operation 246 may additionally or alternatively comprise validating that the synthetic data conforms to a data type and/or data format for the type of software object into which the synthetic data is to be incorporated. For example, this may include using regular expression(s) and/or a machine-learned model to detect portion(s) of synthetic data that would not be accepted as part of a synthetic object according to the configuration file. This may comprise removing any double periods (“ . . . ”) before a file type abbreviation (e.g., “pdf”, “txt”), extraneous carriage returns or spaces, and/or the like. In some examples, operation 246 may occur before operation 244. Additionally or alternatively, operation 246 may comprise deleting and/or modifying synthetic data to conform the synthetic data to the statistical characteristic(s). For example, this may comprise deleting synthetic data from a field, modifying how synthetic data is represented (e.g., changing a phone number from a format such as ###-###-#### to ##########), and/or the like.

Turning to FIG. 2E, at operation 252, example process 200 may comprise determining, based at least in part on the synthetic data and relationship(s) indicated in the configuration file, a set of synthetic objects. For example, operation 252 may comprise populating a data structure associated with a first object type with a set of synthetic data of the first object type. Additionally or alternatively, operation 252 may comprise linking and/or populating portions (fields) of a first object type with data from or a link to a portion of synthetic data of a second object type. In some examples, operation 252 may comprise this linking/relationship creation at a rate indicated by a statistical characteristic for the first object type. For example, although the configuration file may indicate that the first object type is related to a second object type, a statistical characteristic of the first object type may indicate that only 77% of a first type of object(s) includes links to the second object type. Accordingly, in such an example, operation 252 may comprise generating this relationship/linking for only 77% of the synthetic objects of the first object type. Moreover, in some examples, operation 252 may be accomplished according to a topology determined based at least in part on the configuration file. For example, operation 252 may start from a leaf object type (i.e., an object type that has no children and/or no children for which operation 252 has been completed yet, working backwards towards the root object type). In some examples, operation 252 may comprise using synthetic data to generate the software object by a machine-learned model with a very low temperature (e.g., a temperature below 0.2, 0.4, or the like) or a via a deterministic software component.

FIG. 2E illustrates the data contained within synthetic account objects 254, data contained within synthetic contact objects 256, and data contained within synthetic opportunity objects 258. Note that, although this data is depicted in a table, the synthetic object(s) may have a different data structure and/or may comprise different or more than text, all of which depends on the software object(s) being generated. Note, too, that FIG. 2E depicts de-duplicated data in comparison to the synthetic data depicted in FIG. 2C and that the data is anonymized compared to the source data depicted in FIG. 2A.

At operation 260, example process 200 may comprise deploying the set of synthetic objects at the host computing service according to the configuration file. For example, operation 260 may comprise uploading the synthetic object(s) and/or changing permissions associated with a software environment and/or container to allow software component(s) of the production or development software environment to access the synthetic object(s). Additionally or alternatively, operation 260 may comprise deploying the synthetic object(s) in an order identified by the topology determined based at least in part on the configuration. For example, synthetic object(s) associated with a leaf object type, such as “Account” synthetic object(s), may be deployed before the “Contact” synthetic object(s) and before the “Opportunity” synthetic object(s); and “Contact” synthetic object(s) may be deployed before the “Opportunity” synthetic object(s). This pattern may be followed from leaf nodes to parent node(s) until root node(s) are reached. In some examples, deployment may comprise data insertion into a datastore associated with a target organization through SOQL or through API(s). In some examples, operation 260 may additionally or alternatively comprise ensuring that the relationship(s) between the deployed synthetic object(s) have been accurately established. After the synthetic object(s) are deployed, the software environment may be tested.

### EXAMPLE CLAUSES

A. A system comprising: one or more processors; and one or more non-transitory computer-readable media that, when executed by the one or more processors, cause the one or more processors to perform operations comprising: receiving a configuration file indicating a first object type and a relationship between the first object type and a second object type; receiving, in response to a query sent to a host computing service using the configuration file, source data comprising a first set of objects of the first object type and a second set of objects of the second object type; sending, to a transformer-based machine-learned model, a set of input data determined based at least in part on the source data, wherein first input data of the set of input data comprises a prompt and data determined from a subset of objects of the source data; receiving, from the transformer-based machine-learned model, a first set of synthetic data associated with the first object type and a second set of synthetic data associated with the second object type; determining, based at least in part on the first set of synthetic data, the second set of synthetic data, and the relationship indicated in the configuration file, a set of synthetic objects; and deploying, at the host computing service, the set of synthetic objects according to the configuration file.

B. The system of paragraph A, wherein the operations further comprise: determining, based at least in part on the source data, a statistical characteristic of the source data; and determining the prompt based at least in part on including in the prompt at least one of: a first rate at which a portion of the first set of objects is formatted according to a first format; a second rate at which the portion of the first set of objects is empty; a set or range of entries indicated in the portion of the first set of objects and a third rate at which the portion of the first set of objects indicates a particular entry in the set or range of entries; or a fourth rate at which first objects of the first set of objects are indicated as related to second objects of the second set of objects, wherein at least one of the first rate, the second rate, the set or range, the third rate, or the fourth rate are part of the statistical characteristic.

C. The system of paragraph B, wherein determining the set of synthetic objects further comprises at least one of: populating the portion of a first synthetic object with part of the first set of synthetic data according to the statistical characteristic; or creating a relationship between the first synthetic object and a second synthetic object according to the fourth rate and based at least in part on the relationship indicated by the configuration file.

D. The system of any one of paragraphs A-C, wherein the operations further comprise: determining, by an encoder model and based at least in part on the source data, a first set of embeddings; determining, by the encoder model and based at least in part on the first set of synthetic data and the second set of synthetic data, a second set of embeddings; and determining a similarity metric between the second set of embeddings and the first set of embeddings.

E. The system of paragraph D, wherein: deploying the set of synthetic objects at the host computing service comprises determining that the similarity metric meets or exceeds a threshold similarity metric for a percentage of the second set of embeddings that meets or exceeds a threshold percentage; or the operations further comprise: determining that the similarity metric is less than a threshold similarity metric for a percentage of the second set of embeddings that is less than the threshold percentage; and replacing a subset of synthetic objects, for which first synthetic metrics were determined to be less than the threshold similarity metric, with a subset of new synthetic objects.

F. The system of any one of paragraphs A-E, wherein: determining the set of input data comprises determining multiple subsets of input data based at least in part on a first number of synthetic objects indicated by a user or a second number of objects in the source data and determining a maximum input size of the transformer-based machine-learned model; and providing the set of input data comprises separately providing the multiple subsets of input data to different ones of multiple instances of the transformer-based machine-learned model or to different transformer-based machine-learned models.

G. The system of any one of paragraphs A-F, wherein the operations further comprise re-generating, by the transformer-based machine-learned model, a portion of first synthetic data of the first set of synthetic data or discarding the first synthetic data based at least in part on determining that the first synthetic data comprises a first entry or pair of entries that matches a second entry or pair of entries of second synthetic data of the first set of synthetic data; and wherein the portion is identified by the configuration file for de-duplication across the first set of synthetic data associated with the first object type.

H. The system of any one of paragraphs A-G, wherein the operations further comprise creating the configuration file based at least in part on receiving a user indication of a number of synthetic objects to generate and one or more types of objects to generate, and wherein creating the configuration file comprises: transmitting, to the host computing service, a request indicating the one or more types of objects; receiving metadata indicating one or more relationships associated with the first object type and entry types associated with the first object type; and creating the configuration file based at least in part on the one or more relationships and the entry types.

I. The system of any one of paragraphs A-H, wherein deploying the set of synthetic objects according to the configuration file comprises: determining, based at least in part on the relationship indicated by the configuration file, that the second object type is dependent on the first object type; and deploying, at the host computing service, the first set of synthetic objects before deploying the second set of synthetic objects.

J. One or more non transitory computer readable media storing instructions executable by one or more processors, wherein the instructions, when executed, cause the one or more processors to perform operations comprising: receiving a configuration file indicating a first object type and a relationship between the first object type and a second object type; receiving source data comprising a first set of objects having the first object type; sending, to a transformer-based machine-learned model, a set of input data determined based at least in part on the source data, wherein first input data of the set of input data comprises a prompt and a subset of the first set of objects; receiving, from the transformer-based machine-learned model, a set of synthetic data associated with the first object type; determining, based at least in part on the set of synthetic data and the relationship indicated in the configuration file, a set of synthetic objects; and deploying the set of synthetic objects to a host computing service according to the configuration file.

K. The one or more non-transitory computer-readable media of paragraph J, wherein the operations further comprise: determining, based at least in part on the source data, a statistical characteristic of the source data; and determining the prompt based at least in part on including in the prompt at least one of: a first rate at which a portion of the first set of objects is formatted according to a first format; a second rate at which the portion of the first set of objects is empty; a set or range of entries indicated in the portion of the first set of objects and a third rate at which the portion of the first set of objects indicates a particular entry in the set or range of entries; or a fourth rate at which first objects of the first set of objects are indicated as related to second objects, wherein at least one of the first rate, the second rate, the set or range, the third rate, or the fourth rate are part of the statistical characteristic.

L. The one or more non-transitory computer-readable media of paragraph K, wherein determining the set of synthetic objects further comprises at least one of: populating the portion of a first synthetic object with part of the set of synthetic data according to the statistical characteristic; or creating a relationship between the first synthetic object and a second synthetic object according to the fourth rate and based at least in part on the relationship indicated by the configuration file.

M. The one or more non-transitory computer-readable media of any one of paragraphs J-L, wherein the operations further comprise: determining, by an encoder model and based at least in part on the source data, a first set of embeddings; determining, by the encoder model and based at least in part on the set of synthetic data, a second set of embeddings; and determining a similarity metric between the second set of embeddings and the first set of embeddings; and wherein: deploying the set of synthetic objects at the host computing service comprises determining that the similarity metric meets or exceeds a threshold similarity metric for a first percentage of the second set of embeddings that meets or exceeds a threshold percentage; or the operations further comprise: determining that the similarity metric is less than the threshold similarity metric for a second percentage of the second set of embeddings that is less than the threshold percentage; and replacing a subset of synthetic objects, for which first synthetic metrics were determined to be less than the threshold similarity metric, with a subset of new synthetic objects.

N. The one or more non-transitory computer-readable media of any one of paragraphs J-M, wherein: determining the set of input data comprises determining multiple subsets of input data based at least in part on a first number of synthetic objects indicated by a user or a second number of objects in the source data and determining a maximum input size of the transformer-based machine-learned model; and providing the set of input data comprises separately providing the multiple subsets of input data to different ones of multiple instances of the transformer-based machine-learned model or to different transformer-based machine-learned models.

O. The one or more non-transitory computer-readable media of any one of paragraphs J-N, wherein the operations further comprise creating the configuration file based at least in part on receiving a user indication of a number of synthetic objects to generate and one or more types of objects to generate, and wherein creating the configuration file comprises: transmitting, to the host computing service, a request indicating the one or more types of objects; receiving metadata indicating one or more relationships associated with the first object type and entry types associated with the first object type; and creating the configuration file based at least in part on the one or more relationships and the entry types.

P. The one or more non-transitory computer-readable media of any one of paragraphs J-O, wherein deploying the set of synthetic objects according to the configuration file comprises: determining, based at least in part on the relationship indicated by the configuration file, that the second object type is dependent on the first object type; and deploying, at the host computing service, the set of synthetic objects before deploying a second set of synthetic objects having the second object type.

Q. A method comprising: receiving a configuration file indicating a first object type and a relationship between the first object type and a second object type; receiving source data comprising a first set of objects having the first object type; sending, to a transformer-based machine-learned model, a set of input data determined based at least in part on the source data, wherein first input data of the set of input data comprises a prompt and a subset of the first set of objects; receiving, from the transformer-based machine-learned model, a set of synthetic data associated with the first object type; determining, based at least in part on the set of synthetic data and the relationship indicated in the configuration file, a set of synthetic objects; and deploying the set of synthetic objects to a host computing service.

R. The method of paragraph Q, further comprising: determining, based at least in part on the source data, a statistical characteristic of the source data; and determining the prompt based at least in part on including in the prompt the statistical characteristic and a portion of the source data associated with the statistical characteristic; and at least one of: populating the portion of a first synthetic object with part of the set of synthetic data according to the statistical characteristic; or creating a relationship between the first synthetic object and a second synthetic object according to the statistical characteristic and based at least in part on the relationship indicated by the configuration file.

S. The method of either paragraph Q or R, further comprising creating the configuration file based at least in part on receiving a user indication of a number of synthetic objects to generate and one or more types of objects to generate, and wherein creating the configuration file comprises: transmitting, to the host computing service, a request indicating the one or more types of objects; receiving metadata indicating one or more relationships associated with the first object type and entry types associated with the first object type; and creating the configuration file based at least in part on the one or more relationships and the entry types.

T. The method of any one of paragraphs Q-S, wherein deploying the set of synthetic objects comprises: determining, based at least in part on the relationship indicated by the configuration file, that the second object type is dependent on the first object type; and deploying, at the host computing service, the set of synthetic objects before deploying a second set of synthetic objects having the second object type.

While the example clauses described above are described with respect to one particular implementation, it should be understood that, in the context of this document, the content of the example clauses can also be implemented via a method, device, system, a computer-readable medium, and/or another implementation. Additionally, any of examples A-T may be implemented alone or in combination with any other one or more of the examples A-T.

While one or more examples of the techniques described herein have been described, various alterations, additions, permutations and equivalents thereof are included within the scope of the techniques described herein. For example, articles such as “a,” “an,” or “the” should be construed as being one or more elements. Moreover, a set should be construed as 0, 1, or more elements, since a set may be an empty set (i.e., a set comprising zero elements), a singleton (i.e., a set comprising a single element), or a set comprising multiple elements (i.e., a set comprising two or more elements). Moreover, it should be appreciated that the term “subset” describes a proper subset. A proper subset of set is a portion of the set that is not equal to the set. For example, if elements A, B, and C belong to a first set, a subset including elements A and B is a proper subset of the first set. However, a subset including elements A, B, and C is not a proper subset of the first set.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types. Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

What is claimed is:

1. A system comprising:
one or more processors; and
one or more non-transitory computer-readable media that, when executed by the one or more processors, cause the one or more processors to perform operations comprising:
receiving a configuration file indicating a first object type and a relationship between the first object type and a second object type;
receiving, in response to a query sent to a host computing service using the configuration file, source data comprising a first set of objects of the first object type and a second set of objects of the second object type;
sending, to a transformer-based machine-learned model, a set of input data determined based at least in part on the source data, wherein first input data of the set of input data comprises a prompt and data determined from a subset of objects of the source data;
receiving, from the transformer-based machine-learned model, a first set of synthetic data associated with the first object type and a second set of synthetic data associated with the second object type;
determining, based at least in part on the first set of synthetic data, the second set of synthetic data, and the relationship indicated in the configuration file, a set of synthetic objects; and
deploying, at the host computing service, the set of synthetic objects according to the configuration file.

2. The system of claim 1, wherein the operations further comprise:
determining, based at least in part on the source data, a statistical characteristic of the source data; and
determining the prompt based at least in part on including in the prompt at least one of:
a first rate at which a portion of the first set of objects is formatted according to a first format;
a second rate at which the portion of the first set of objects is empty;
a set or range of entries indicated in the portion of the first set of objects and a third rate at which the portion of the first set of objects indicates a particular entry in the set or range of entries; or
a fourth rate at which first objects of the first set of objects are indicated as related to second objects of the second set of objects,
wherein at least one of the first rate, the second rate, the set or range, the third rate, or the fourth rate are part of the statistical characteristic.

3. The system of claim 2, wherein determining the set of synthetic objects further comprises at least one of:
populating the portion of a first synthetic object with part of the first set of synthetic data according to the statistical characteristic; or
creating a relationship between the first synthetic object and a second synthetic object according to the fourth rate and based at least in part on the relationship indicated by the configuration file.

4. The system of claim 1, wherein the operations further comprise:
determining, by an encoder model and based at least in part on the source data, a first set of embeddings;
determining, by the encoder model and based at least in part on the first set of synthetic data and the second set of synthetic data, a second set of embeddings; and
determining a similarity metric between the second set of embeddings and the first set of embeddings.

5. The system of claim 4, wherein:
deploying the set of synthetic objects at the host computing service comprises determining that the similarity metric meets or exceeds a threshold similarity metric for a percentage of the second set of embeddings that meets or exceeds a threshold percentage; or
the operations further comprise:
determining that the similarity metric is less than a threshold similarity metric for a percentage of the second set of embeddings that is less than the threshold percentage; and
replacing a subset of synthetic objects, for which first synthetic metrics were determined to be less than the threshold similarity metric, with a subset of new synthetic objects.

6. The system of claim 1, wherein:
determining the set of input data comprises determining multiple subsets of input data based at least in part on a first number of synthetic objects indicated by a user or a second number of objects in the source data and determining a maximum input size of the transformer-based machine-learned model; and
providing the set of input data comprises separately providing the multiple subsets of input data to different ones of multiple instances of the transformer-based machine-learned model or to different transformer-based machine-learned models.

7. The system of claim 1, wherein the operations further comprise re-generating, by the transformer-based machine-learned model, a portion of first synthetic data of the first set of synthetic data or discarding the first synthetic data based at least in part on determining that the first synthetic data comprises a first entry or pair of entries that matches a second entry or pair of entries of second synthetic data of the first set of synthetic data; and
wherein the portion is identified by the configuration file for de-duplication across the first set of synthetic data associated with the first object type.

8. The system of claim 1, wherein the operations further comprise creating the configuration file based at least in part on receiving a user indication of a number of synthetic objects to generate and one or more types of objects to generate, and wherein creating the configuration file comprises:
transmitting, to the host computing service, a request indicating the one or more types of objects;
receiving metadata indicating one or more relationships associated with the first object type and entry types associated with the first object type; and
creating the configuration file based at least in part on the one or more relationships and the entry types.

9. The system of claim 1, wherein deploying the set of synthetic objects according to the configuration file comprises:
determining, based at least in part on the relationship indicated by the configuration file, that the second object type is dependent on the first object type; and
deploying, at the host computing service, the first set of synthetic objects before deploying the second set of synthetic objects.

10. One or more non-transitory computer-readable media storing instructions executable by one or more processors, wherein the instructions, when executed, cause the one or more processors to perform operations comprising:
receiving a configuration file indicating a first object type and a relationship between the first object type and a second object type;
receiving source data comprising a first set of objects having the first object type;
sending, to a transformer-based machine-learned model, a set of input data determined based at least in part on the source data, wherein first input data of the set of input data comprises a prompt and a subset of the first set of objects;
receiving, from the transformer-based machine-learned model, a set of synthetic data associated with the first object type;
determining, based at least in part on the set of synthetic data and the relationship indicated in the configuration file, a set of synthetic objects; and
deploying the set of synthetic objects to a host computing service according to the configuration file.

11. The one or more non-transitory computer-readable media of claim 10, wherein the operations further comprise:
determining, based at least in part on the source data, a statistical characteristic of the source data; and
determining the prompt based at least in part on including in the prompt at least one of:
a first rate at which a portion of the first set of objects is formatted according to a first format;
a second rate at which the portion of the first set of objects is empty;
a set or range of entries indicated in the portion of the first set of objects and a third rate at which the portion of the first set of objects indicates a particular entry in the set or range of entries; or
a fourth rate at which first objects of the first set of objects are indicated as related to second objects,
wherein at least one of the first rate, the second rate, the set or range, the third rate, or the fourth rate are part of the statistical characteristic.

12. The one or more non-transitory computer-readable media of claim 11, wherein determining the set of synthetic objects further comprises at least one of:
populating the portion of a first synthetic object with part of the set of synthetic data according to the statistical characteristic; or
creating a relationship between the first synthetic object and a second synthetic object according to the fourth rate and based at least in part on the relationship indicated by the configuration file.

13. The one or more non-transitory computer-readable media of claim 10, wherein the operations further comprise:
determining, by an encoder model and based at least in part on the source data, a first set of embeddings;
determining, by the encoder model and based at least in part on the set of synthetic data, a second set of embeddings; and
determining a similarity metric between the second set of embeddings and the first set of embeddings; and
wherein:
deploying the set of synthetic objects at the host computing service comprises determining that the similarity metric meets or exceeds a threshold similarity metric for a first percentage of the second set of embeddings that meets or exceeds a threshold percentage; or
the operations further comprise:
determining that the similarity metric is less than the threshold similarity metric for a second percentage of the second set of embeddings that is less than the threshold percentage; and
replacing a subset of synthetic objects, for which first synthetic metrics were determined to be less than the threshold similarity metric, with a subset of new synthetic objects.

14. The one or more non-transitory computer-readable media of claim 10, wherein:
determining the set of input data comprises determining multiple subsets of input data based at least in part on a first number of synthetic objects indicated by a user or a second number of objects in the source data and determining a maximum input size of the transformer-based machine-learned model; and
providing the set of input data comprises separately providing the multiple subsets of input data to different ones of multiple instances of the transformer-based machine-learned model or to different transformer-based machine-learned models.

15. The one or more non-transitory computer-readable media of claim 10, wherein the operations further comprise creating the configuration file based at least in part on receiving a user indication of a number of synthetic objects to generate and one or more types of objects to generate, and wherein creating the configuration file comprises:
transmitting, to the host computing service, a request indicating the one or more types of objects;
receiving metadata indicating one or more relationships associated with the first object type and entry types associated with the first object type; and
creating the configuration file based at least in part on the one or more relationships and the entry types.

16. The one or more non-transitory computer-readable media of claim 10, wherein deploying the set of synthetic objects according to the configuration file comprises:
determining, based at least in part on the relationship indicated by the configuration file, that the second object type is dependent on the first object type; and
deploying, at the host computing service, the set of synthetic objects before deploying a second set of synthetic objects having the second object type.

17. A method comprising:
receiving a configuration file indicating a first object type and a relationship between the first object type and a second object type;
receiving source data comprising a first set of objects having the first object type;
sending, to a transformer-based machine-learned model, a set of input data determined based at least in part on the source data, wherein first input data of the set of input data comprises a prompt and a subset of the first set of objects;
receiving, from the transformer-based machine-learned model, a set of synthetic data associated with the first object type;
determining, based at least in part on the set of synthetic data and the relationship indicated in the configuration file, a set of synthetic objects; and
deploying the set of synthetic objects to a host computing service.

18. The method of claim 17, further comprising:
determining, based at least in part on the source data, a statistical characteristic of the source data; and
determining the prompt based at least in part on including in the prompt the statistical characteristic and a portion of the source data associated with the statistical characteristic; and at least one of:
populating the portion of a first synthetic object with part of the set of synthetic data according to the statistical characteristic; or
creating a relationship between the first synthetic object and a second synthetic object according to the statistical characteristic and based at least in part on the relationship indicated by the configuration file.

19. The method of claim 17, further comprising creating the configuration file based at least in part on receiving a user indication of a number of synthetic objects to generate and one or more types of objects to generate, and wherein creating the configuration file comprises:
transmitting, to the host computing service, a request indicating the one or more types of objects;
receiving metadata indicating one or more relationships associated with the first object type and entry types associated with the first object type; and
creating the configuration file based at least in part on the one or more relationships and the entry types.

20. The method of claim 17, wherein deploying the set of synthetic objects comprises:
determining, based at least in part on the relationship indicated by the configuration file, that the second object type is dependent on the first object type; and
deploying, at the host computing service, the set of synthetic objects before deploying a second set of synthetic objects having the second object type.
